(19) United States
(12) Patent Application Publication
(10) Pub. No.: US 2013/0136661 A1
(43) Pub. Date: May 30, 2013

(54) Hydrogen production structure and method for fabricating the same

(71) Applicants: TSAI-HSIN CHENG, HSINCHU COUNTY (TW); PO-KUEI CHOU, HSINCHU COUNTY (TW); DIN-SUN JU, HSINCHU COUNTY (TW)

(72) Inventors: TSAI-HSIN CHENG, HSINCHU COUNTY (TW); PO-KUEI CHOU, HSINCHU COUNTY (TW); DIN-SUN JU, HSINCHU COUNTY (TW)

(21) Appl. No.: 13/682,279

(22) Filed: Nov. 20, 2012

(30) Foreign Application Priority Data
Nov. 28, 2011 (CN) 201110384098.1

(51) Int. Cl. B01J 8/00

(52) U.S. Cl. CPC B01J 8/00
USPC 422/162; 264/122

(57) ABSTRACT

A hydrogen production structure includes a plurality of hollow fuel blocks having respective reaction rates for hydrogen production. Each of the hollow fuel blocks includes at least non-woven fibers and a solid-state reactant for hydrogen production, and the non-woven fibers and the solid-state reactant are bound together.

### BACKGROUND OF THE INVENTION

a. Field of the Invention

The invention relates to a hydrogen production structure and a method for fabricating the hydrogen production structure.

b. Description of the Related Art

A fuel cell (FC) is a power generation device using hydrogen, typically from a hydrogen production device, as a fuel. In a conventional hydrogen production device, water reacts with a solid-state reactant (such as Sodium Borohydride) to generate hydrogen, and the solid-state reactant is often pressed to form a block shape to reduce its size. However, since water is only supplied one time in a conventional hydrogen production process, hydrogen is instantaneous produced to a full extent at an initial stage to result in low utilization efficiency of fuel and unsteady and short-term hydrogen supply. Further, in case the solid-state reactant is pressed to form a block shape, the one-time supply of water may render incomplete reaction of a fuel block and water. Besides, fuel blocks in conventional designs often encounter a problem of low initial hydrogen production.

Taiwan Patent No. 1296296 discloses fibers immersed in a solution with additives to allow the additives to deposit on the fibers. Taiwan Patent publication No. 200703763 discloses a liquid-state reactant reacting with a metal-hydride fuel and a catalyst to produce hydrogen. U.S. Pat. No. 7,056,581 discloses a core-sheath composite fiber has a core layer and a sheath layer surrounding the core layer. U.S. Pat. No. 6,746,496 discloses a hydrogen generator for a power device, where the hydrogen generator has micro diffusion particles with a catalyst, and the micro diffusion particles react with water to generate hydrogen. U.S. Patent application publication No. 20080233462 discloses a solid fuel container made of multi-layer materials.

### BRIEF SUMMARY OF THE INVENTION

The invention provides a hydrogen production structure reacting with a solution to produce hydrogen.

The invention also provides a method for fabricating the hydrogen production structure.

Other objects and advantages of the invention can be better understood from the technical characteristics disclosed by the invention. In order to achieve one of the above purposes, all the purposes, or other purposes, one embodiment of the invention provides a hydrogen production structure including a plurality of hollow fuel blocks having respective reaction rates for hydrogen production. Each of the hollow fuel blocks includes non-woven fibers and a solid-state reactant for hydrogen production, and the non-woven fibers and the solid-state reactant are bound together.

In one embodiment, the hydrogen production structure further includes a water-absorption material surrounding the hollow fuel blocks, and the water-absorption material may include at least one of absorbent cotton, a hydrophilic porous material, an acid porous material, an alkaline porous material, melamine, trimeric cyanamide, foam, cotton and fibers.

In one embodiment, the non-woven fibers include a plurality of core-sheath fibers, and each of the core-sheath fibers includes a core layer having a first melting point and a sheath layer surrounding the core layer and having a second melting point, where the first melting point is higher than the second melting point.

In one embodiment, the non-woven fibers include at least one of rayon fibers and polymer fibers, and a hot melt powder is added to at least one of the hollow fuel blocks.

In one embodiment, a solid acid powder and a catalyst are added to at least one of the hollow fuel blocks. The solid acid powder may include at least one of Malic acid, Citric acid, Sulfate, Phosphates and a metal salt, and the catalyst may include at least one of cobalt (Co), cobalt boride (CoB), dicobalt boride (Co₂B), cobalt diboride (CoB₂), and dicobalt triboride (Co₂B₃).

The hollow fuel blocks include a first fuel block, a second fuel block, and a third fuel block, the solid acid powder is added to the first fuel block, the first catalyst is added to the second fuel block, and the second catalyst is added to the third fuel block. The first catalyst and the second catalyst are different in kind or have different concentrations.

According to another embodiment of the invention, a method for fabricating a hydrogen production structure including the steps of molding a mixture of non-woven fibers, a hot melt powder, and a solid-state reactant for hydrogen production placed in a die to form a hollow block body, and baking the hollow block body.

According to another embodiment of the invention, a method for fabricating the hydrogen production structure including the steps of baking a mixture of non-woven fibers, a hot melt powder, and a solid-state reactant for hydrogen production, where the hot melt powder melts to bind the non-woven fibers and the solid-state reactant together to form a block body, rolling the block body to form a hollow block body, and baking the hollow block body.

In conclusion, at least one of the embodiments of the invention may have at least one of the following advantages.

According to the above embodiment, since a solid acid powder and a catalyst may be optionally added to the fuel blocks, and the kind, amount or concentration of the solid acid powder and the catalyst may be arbitrary adjusted, the fuel blocks are allowed to have respective reaction rates for hydrogen production to steadily produce hydrogen for a long period. Further, each fuel block may have a hollow shape to reduce overall thickness, and hence a solid-state reactant even in a deep layer of the fuel block is allowed to completely react with water. Besides, the hollow shape of fuel blocks may also increase reaction areas and enhance heat-dissipation efficiency. Moreover, the solid acid powder may provide an acidic environment for the solid-state reactant to produce hydrogen with a high flow rate initially. In addition, since the water-absorption material surrounding hollow fuel blocks has a high capability to absorb water, the contact areas between an aqueous solution and the hollow fuel blocks are increased, and, even the hydrogen production structure is disposed at different orientations, the aqueous solution may still react with the hollow fuel blocks without being influenced by the force of gravity.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 shows a schematic diagram illustrating a hydrogen production structure according to an embodiment of the invention.

FIG. 2A shows a schematic diagram illustrating a hollow fuel block according to an embodiment of the invention.

FIG. 2B shows a schematic diagram illustrating a hollow fuel block according to another embodiment of the invention.

FIG. 3 shows a curve diagram illustrating respective reaction rates of different hollow fuel blocks for hydrogen production.

FIG. 4 shows a curve diagram illustrating a reaction rate of a hydrogen production structure having multiple hollow fuel blocks.

FIG. 5 shows a schematic diagram illustrating functions of a water-absorption material according to an embodiment of the invention.

FIG. 6 shows a flow chart illustrating a fabrication method for a hydrogen production structure according to an embodiment of the invention.

FIG. 7 shows a flow chart illustrating a fabrication method for a hydrogen production structure according to another embodiment of the invention.

### DETAILED DESCRIPTION OF THE INVENTION

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

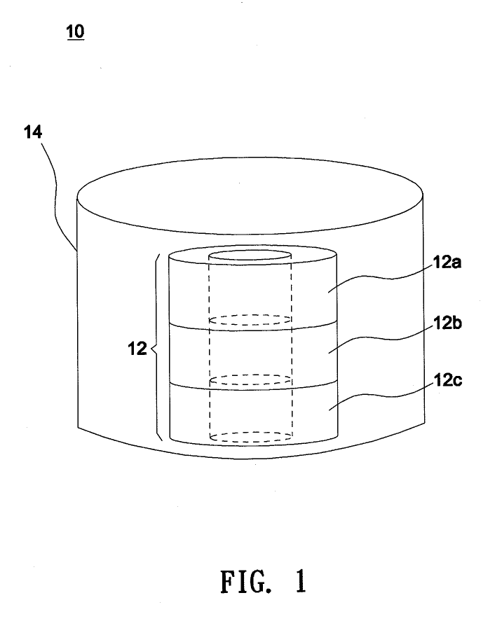

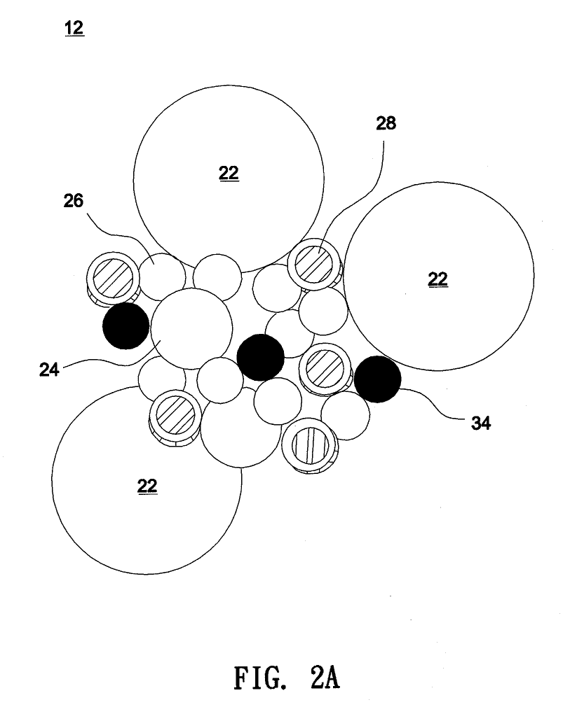

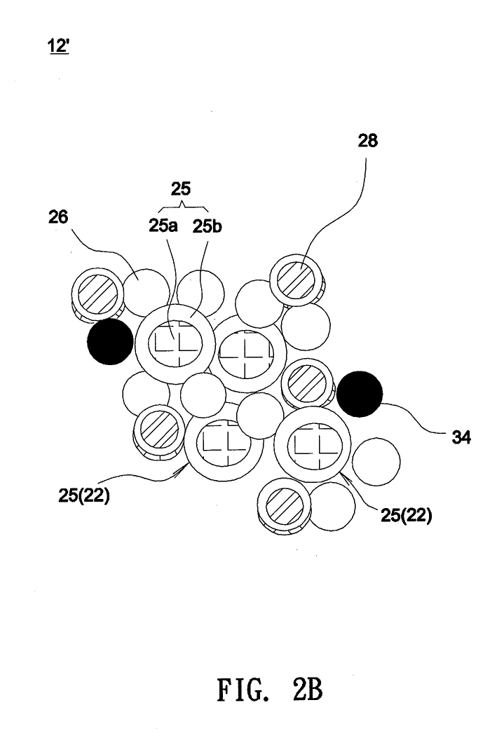

Referring to FIG. 1, a hydrogen production structure 10 includes a plurality of hollow fuel blocks 12 (such as a first fuel block 12a, a second fuel block 12b, and a third fuel block 12c) having respective reaction rates for hydrogen production. A water-absorption material 14 may surround the hollow fuel blocks 12. As shown in FIG. 2A, each hollow fuel block 12 may include non-woven fibers 22, a hot melt powder 24 and a solid-state reactant 26 for hydrogen production, and the non-woven fibers 22, the hot melt powder 24, and the solid-state reactant 26 are bound together. In this embodiment, the non-woven fibers 22 may include at least one of polymer fibers and rayon fibers, and the polymer fibers may be made of Polyvinyl Chloride, Polystyrene, Polyethylene or Polypropylene. Besides, a solid acid powder 28 or a catalyst 34 may be added to any one of the hollow fuel blocks 12 of the hydrogen production structure 10. The non-woven fibers 22 may be used as a frame of the hollow fuel block 12, and the hot melt powder 24 is used to bind the non-woven fibers 22, the solid-state reactant 26, and the solid acid powder 28 to form a predetermined shape. In one embodiment, the weight percentage of the non-woven fibers 22 in the hydrogen production structure 10 is 0.5%-40%, and preferably 5%-20%. The hot melt powder 24 may be made of plastic, such as Polyethylene, having a lower melting point. Further, in one embodiment, the mass percentage of the hot melt powder 24 in the hydrogen production structure 10 is 0.5%-40%, and preferably 5%-20% to achieve better binding capability and structural strength. Certainly, the mass percentage of the hot melt powder 24 can be arbitrary selected according to actual demands.

Referring to FIG. 2B, in an alternate embodiment, non-woven fibers 22 of a hollow fuel block 12′ may include a plurality of core-sheath fibers 25. Each of the core-sheath fibers 25 includes a core layer 25a and a sheath layer 25b surrounding the core layer 25a. The core layer 25a and the sheath layer 25b may be made of plastic, and the melting point of the core layer 25a is higher than the melting point of the sheath layer 25b. For example, the core layer 25a may be made of Polypropylene with a melting point of about 180° C., and the sheath layer 25b may be made of Polyethylene with a melting point of about 127° C. Therefore, when the core-sheath fibers 25 are heated at a temperature between the melting point of the core layer 25a and the melting point of the sheath layer 25b, the sheath layer 25b melts to bind the solid-state reactant 26 and the solid acid powder 28 together, and the core layer 25a does not melt so that the core layer 25a may support the entire hydrogen production structure. The solid acid powder 28 may include Malic acid, Citric acid, Sulfate, Phosphates and a metal salt, and the metal salt may include Sodium Chloride, Calcium Oxide, Potassium Iodide, etc. In one embodiment, the weight percentage of the solid acid powder 28 in the hydrogen production structure 10 is 0.5%-40%, and preferably 5%-20%. Since the reaction rate of the solid-state reactant 26 is higher in an acidic environment, the solid acid powder 28 providing an acidic environment for the solid-state reactant 26, so as to produce hydrogen with a higher flow rate initially. This may prevent low initial hydrogen production afforded by conventional designs.

In one embodiment, the catalyst 34 is added to the hydrogen production structure 10 and combined with the hot melt powder 24 or the core-sheath fibers 25 to facilitate hydrogen production and enhance the flow rate and yield of hydrogen production. The solid-state reactant 26 may include metallic particles or metal hydride particles such as Sodium Borohydride, Magnesium Hydride, Calcium Hydride, Aluminum powders, etc, and the catalyst 34 may include cobalt (Co), cobalt boride (CoB), dicobalt boride (Co₂B), cobalt diboride (CoB₂), dicobalt triboride (Co₂B₃), etc.

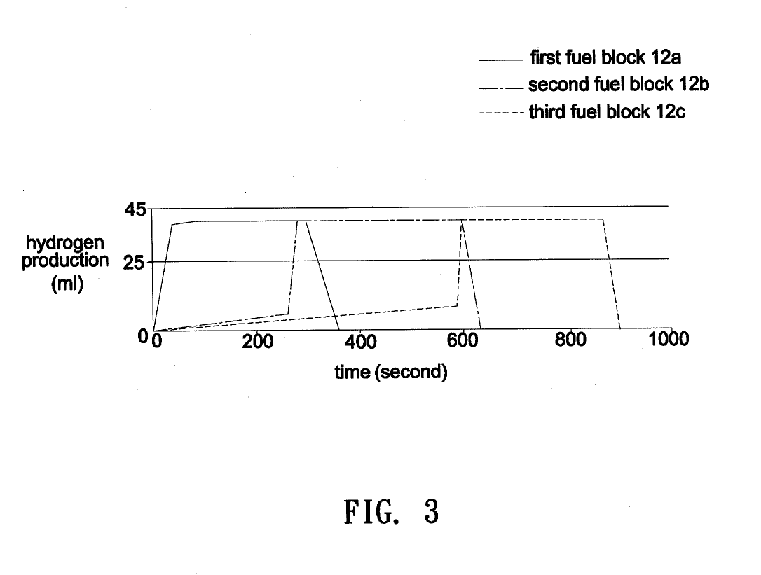

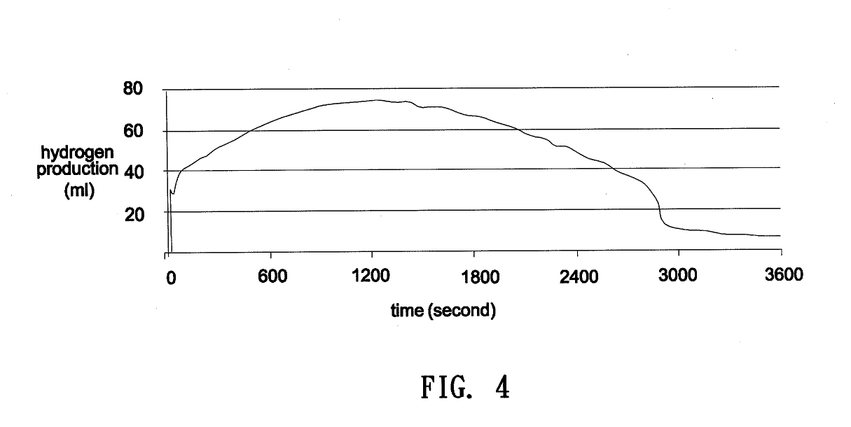

Please refer to FIG. 1 again, in one embodiment, the solid acid powder 28 is added to the first fuel block 12a, a catalyst 34 with a higher weight concentration is added to the second fuel block 12b, and another catalyst 34 with a lower weight concentration is added to the third fuel block 12c. In that case, the solid acid powder 28 causes a higher flow rate of hydrogen initially, and the catalysts 34 with different weight concentrations allow for different reaction rates of the second fuel block 12b and the third fuel block 12c for hydrogen production. In an alternate embodiment, the solid acid powder 28 is added to the first fuel block 12a, a catalyst 34 with higher catalytic effects is added to the second fuel block 12b, and another catalyst 34 with lower catalytic effects is added to the third fuel block 12c. Therefore, since the solid acid powder 28 and the catalyst 34 may be optionally added to the fuel blocks 12, and the kind, amount or concentration of the solid acid powder 28 and the catalyst 34 may be arbitrary adjusted, the fuel blocks 12a, 12b and 12c may react to produce hydrogen according to respective reaction curves sown in FIG. 3. Under the circumstance, the sum of produced hydrogen of three fuel blocks 12a, 12b and 12c allows for steadily producing hydrogen for a long period, as shown in FIG. 4.

The formula of Sodium Borohydride, serving as the solid-state reactant 26, reacting with an adequate amount of an aqueous solution for producing hydrogen could be denoted:

NaBH₄+2H₂O→NaBO₂+4H₂ (1)

Once the solid-state reactant 26 reacts with excess aqueous solution, water of crystallization is formed and the hydrogen production equation would be:

NaBH₄+6H₂O→NaB(OH)₄.2H₂O+4H₂ (2)

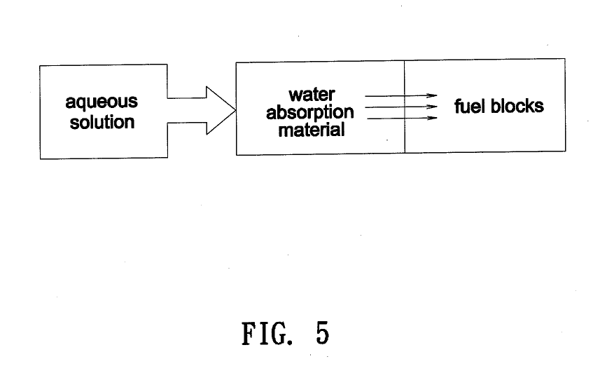

The water of crystallization may deposit on surfaces of the hollow fuel blocks 12 to decrease contact areas where the aqueous solution continually touches the hollow fuel blocks 12. Therefore, a water-absorption material 14 may surround the hollow fuel blocks 12 to avoid the formation of water of crystallization. As shown in FIG. 5, the water-absorption material 14 absorbs the aqueous solution and causes the aqueous solution to move to the hollow fuel blocks 12, so the contact areas between the aqueous solution and the hollow fuel blocks 12 are increased. Further, since the water-absorption material 14 has a high capability to absorb water, the aqueous solution is retained in the water-absorption material 14 as a result of siphon phenomenon and continually reacts with the hollow fuel blocks 12. Accordingly, even the hydrogen production structure 10 is disposed at different orientations, the aqueous solution may still react with the hollow fuel blocks 12 without being influenced by the force of gravity. The water-absorption material 14 may, for instance, include at least one of absorbent cotton, a hydrophilic porous material, an acid porous material, an alkaline porous material, melamine, trimeric cyanamide, foam, cotton, and fibers.

Further, each of the fuel blocks 12 may have a hollow shape to reduce overall thickness, and hence the solid-state reactant 26 even in a deep layer of the fuel block 12 is allowed to completely react with water. Besides, the hollow shape of each fuel block 12 is allowed to increase reaction areas and enhance heat-dissipation. Certainly, the fuel blocks 12 are not limited to a specific shape, as long as the hollowness is maintained.

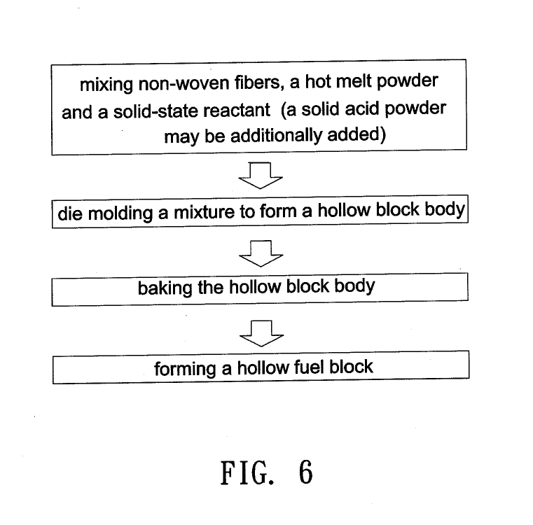

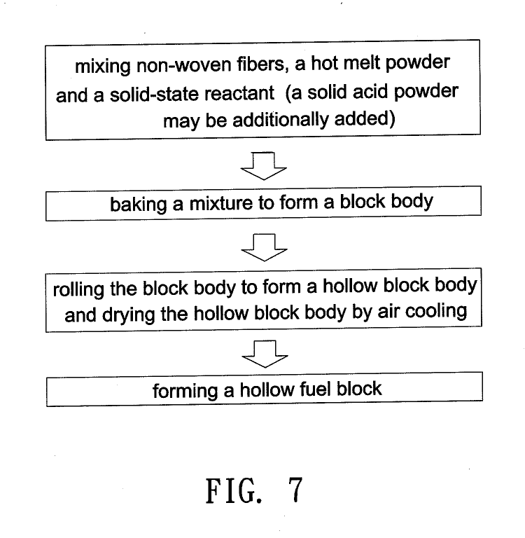

A method for fabricating hollow fuel blocks 12 according to different embodiments of the invention is described in the following. Referring to FIG. 6, in one embodiment, the non-woven fibers 22, the hot melt powder 24 and the solid-state reactant 26 for hydrogen production (the solid acid powder 28 may be additionally added) are mixed and placed inside a die, and the mixture is molded to form a hollow block body. For example, the mixture may be molded by an annular ingot jig and pressed with a force of 0.01-25 kg/cm² and then baked under 140□ to form a hollow fuel block 12. As shown in FIG. 7, in an alternate embodiment, the non-woven fibers 22, the hot melt powder 24, and the solid-state reactant 26 for hydrogen production (the solid acid powder 28 may be additionally added) are mixed and then baked under 140□. In that case, the hot melt powder 24 may melt to bind the non-woven fibers 22 and the solid-state reactant 26 together to form a block body. Thereafter, the block body is rolled by a roller to form a hollow block body and then dried by air cooling to form a hollow fuel block 12. Further, in the above embodiments, the hot melt powder 24 may be omitted in case the non-woven fibers 22 are core-sheath fibers 25.

In conclusion, at one of the embodiments of the invention may have at least one of the following advantages.

According to the above embodiment, since a solid acid powder and a catalyst may be optionally added to the fuel blocks, and the kind, amount or concentration of the solid acid powder and the catalyst may be arbitrary adjusted, the fuel blocks are allowed to have respective reaction rates for hydrogen production to steadily produce hydrogen for a long period. Further, each fuel block may have a hollow shape to reduce overall thickness, and hence a solid-state reactant even in a deep layer of the fuel block is allowed to completely react with water. Besides, the hollow shape of fuel blocks may also increase reaction areas and enhance heat-dissipation. Moreover, the solid acid powder may provide an acidic environment for the solid-state reactant to result in a high speed of initial hydrogen production. In addition, since the water-absorption material surrounding hollow fuel blocks has a high capability to absorb water, the contact areas between an aqueous solution and the hollow fuel blocks are increased, and, even the hydrogen production structure is disposed at different orientations, the aqueous solution may still react with the hollow fuel blocks without being influenced by the force of gravity.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims. Each of the terms “first” and “second” is only a nomenclature used to modify its corresponding element. These terms are not used to set up the upper limit or lower limit of the number of elements.

What is claimed is:

1. A hydrogen production structure comprising a plurality of hollow fuel blocks having respective reaction rates for hydrogen production, wherein each of the hollow fuel blocks comprises non-woven fibers and a solid-state reactant for hydrogen production, and the non-woven fibers and the solid-state reactant are bound together.

2. The hydrogen production structure as claimed in claim 1, further comprising:
a water-absorption material surrounding the hollow fuel blocks.

3. The hydrogen production structure as claimed in claim 2, wherein the water-absorption material comprises at least one of absorbent cotton, a hydrophilic porous material, an acid porous material, an alkaline porous material, melamine, trimeric cyanamide, foam, cotton, and fibers.

4. The hydrogen production structure as claimed in claim 1, wherein the non-woven fibers comprise a plurality of core-sheath fibers and each of the core-sheath fibers comprises:
a core layer having a first melting point; and
a sheath layer surrounding the core layer and having a second melting point, wherein the first melting point is higher than the second melting point.

5. The hydrogen production structure as claimed in claim 1, wherein the non-woven fibers comprise at least one of rayon fibers and polymer fibers.

6. The hydrogen production structure as claimed in claim 5, further comprising:
a hot melt powder added to at least one of the hollow fuel blocks.

7. The hydrogen production structure as claimed in claim 6, wherein the weight percentage of the hot melt powder in the hydrogen production structure is 5%-20%.

8. The hydrogen production structure as claimed in claim 1, wherein the solid-state reactant for hydrogen production comprises at least one of Sodium Borohydride, Magnesium Hydride, Calcium Hydride, and Aluminum powders.

9. The hydrogen production structure as claimed in claim 1, further comprising:
a solid acid powder added to at least one of the hollow fuel blocks.

10. The hydrogen production structure as claimed in claim 9, wherein the solid acid powder comprises at least one of Malic acid, Citric acid, Sulfate, Phosphates, and a metal salt.

11. The hydrogen production structure as claimed in claim 10, wherein the weight percentage of the solid acid powder in the hydrogen production structure is 5%-20%.

12. The hydrogen production structure as claimed in claim 1, further comprising:
a catalyst added to at least one of hollow fuel blocks.

13. The hydrogen production structure as claimed in claim 12, wherein the catalyst comprises at least one of cobalt (Co), cobalt boride (CoB), dicobalt boride (Co₂B), cobalt diboride (CoB₂) and dicobalt triboride (Co₂B₃).

14. The hydrogen production structure as claimed in claim 1, further comprising a solid acid powder, a first catalyst and a second catalyst, wherein the hollow fuel blocks comprise a first fuel block, a second fuel block, and a third fuel block, the solid acid powder is added to the first fuel block, the first catalyst is added to the second fuel block, the second catalyst is added to the third fuel block, and the first catalyst and the second catalyst are different in kind.

15. The hydrogen production structure as claimed in claim 1, further comprising a solid acid powder, a first catalyst, and a second catalyst, wherein the hollow fuel blocks comprise a first fuel block, a second fuel block, and a third fuel block, the solid acid powder is added to the first fuel block, the first catalyst is added to the second fuel block, the second catalyst is added to the third fuel block, and the first catalyst and the second catalyst have different concentrations.

16. A method for fabricating a hydrogen production structure, comprising the steps of:
molding a mixture of non-woven fibers, a hot melt powder, and a solid-state reactant for hydrogen production placed in a die to form a hollow block body; and
baking the hollow block body.

17. The method for fabricating the hydrogen production structure as claimed in claim 16, further comprising:
adding a solid acid powder to the mixture of the non-woven fibers, the hot melt powder and the solid-state reactant.

18. A method for fabricating a hydrogen production structure, comprising the steps of:
baking a mixture of non-woven fibers, a hot melt powder, and a solid-state reactant for hydrogen production, wherein the hot melt powder melts to bind the non-woven fibers and the solid-state reactant together to form a block body;
rolling the block body to form a hollow block body; and
baking the hollow block body.

19. The method for fabricating the hydrogen production structure as claimed in claim 18, further comprising:
adding a solid acid powder to the mixture of the non-woven fibers, the hot melt powder and the solid-state reactant.
